(19) United States
(12) Patent Application Publication
(10) Pub. No.: US 2010/0281469 A1
(43) Pub. Date: Nov. 4, 2010

(54) SYMBOLIC PREDICTIVE ANALYSIS FOR CONCURRENT PROGRAMS

(75) Inventors: Chao Wang, Plainsboro, NJ (US); Malay Ganai, Plainsboro, NJ (US); Aarti Gupta, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/726,764

(22) Filed: Mar. 18, 2010

Related U.S. Application Data
(60) Provisional application No. 61/174,128, filed on Apr. 30, 2009.
(60) Provisional application No. 61/247,281, filed on Sep. 30, 2009.

(51) Int. Cl. G06F 9/44

(52) U.S. Cl. 717/128; 717/131

(57) ABSTRACT

A symbolic predictive analysis method for finding assertion violations and atomicity violations in concurrent programs is shown that derives a concurrent trace program (CTP) for a program under a given test. A logic formula is then generated based on a concurrent static single assignment (CSSA) representation of the CTP, including at least one assertion property or atomicity violation. The satisfiability of the formula is then determined, such that the outcome of the determination indicates an assertion/atomicity violation.

### RELATED APPLICATION INFORMATION

This application claims priority to provisional application Ser. Nos. 61/174,128 filed on Apr. 30, 2009 and 61/247,281 filed on Sep. 30, 2009, both incorporated herein by reference.

### BACKGROUND

1. Technical Field

The present invention relates to symbolic predictive analysis of computer programs and more particularly to methods and systems for predicting concurrency and atomicity violations in concurrent programs.

2. Description of the Related Art

Predictive analysis aims at detecting concurrency errors by observing execution traces of a concurrent program which may be non-erroneous. Due to the inherent nondeterminism in scheduling concurrent processes/threads, executing a program with the same test input may lead to different program behaviors. This poses a significant challenge in testing concurrent programs—even if a test input may cause a failure, the erroneous interleaving manifesting the failure may not be executed during testing. Furthermore, merely executing the same test multiple times does not always increase the interleaving coverage. In predictive analysis, a concrete execution trace is given, together with a correctness property in the form of assertions embedded in the trace. The given execution trace need not violate the property; but there may exist an alternative trace, i.e., a feasible permutation of events of the given trace, that violates the property. The goal of predictive analysis is detecting such erroneous traces by statically analyzing the given execution trace without re-executing the program.

Prior art predictive analysis algorithms can be classified into two categories based on the quality of reported bugs. The first category consists of methods that do not miss real errors but may report bogus errors. Historically, algorithms that are based on lockset analysis fall into the first category. They strive to cover all possible interleavings that are feasible permutations of events of the given trace, but at the same time may introduce some interleavings that can never appear in the actual program execution. The second category consists of methods that do not report bogus errors but may miss some real errors. Algorithms that are based on happens-before causality often fall into the second category. They provide the feasibility guarantee—that all the reported erroneous interleavings are actual program executions—but they do not cover all interleavings.

### SUMMARY

Accordingly, techniques are wherein presented which meet the feasibility guarantee, and which outperform prior-art algorithms. According to the present principles, a method for symbolic predictive analysis for finding assertion violations in concurrent programs is shown that includes deriving a concurrent trace program (CTP) for a program under test, generating a logic formula based on a concurrent static single assignment (CSSA) representation of the CTP, wherein the formula includes at least one assertion property, and determining the satisfiability of the formula with a processor, wherein a determination of formula satisfiability indicates an assertion violation.

A further embodiment of the present principles includes a method for symbolic predictive analysis for finding assertion violations in concurrent programs that includes deriving a CTP for a program under test, generating a logic formula based on a CSSA representation of the CTP, wherein the formula includes at least one atomicity violation, and determining the satisfiability of the formula with a processor, wherein a determination of formula satisfiability indicates an atomicity violation.

A further embodiment of the present principles includes a system for symbolic predictive analysis for finding concurrency violations in concurrent programs that includes a CTP module that derives a CTP for a program under test, a CSSA module that generates a logic formula based on a CS SA representation of the CTP, wherein the formula includes a condition for a concurrency violation, and a satisfiability module that determines the satisfiability of the formula with a processor, wherein a determination of formula satisfiability indicates a concurrency violation.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 depicts a multithreaded program execution trace according to the present principles.

FIG. 2 depicts a symbolic representation of the execution trace shown in FIG. 1.

FIG. 3 depicts a concurrent static single assignment encoding of the concurrent trace program (CTP) shown in FIG. 2.

FIG. 4 depicts an encoding of path conditions, program order, and variable definitions for the CTP shown in FIG. 2.

FIG. 5 depicts a CSSA encoding of a CTP.

FIG. 6a depicts an execution trace.

FIG. 6b depicts an erroneous prefix related to the execution trace of FIG. 6a.

FIG. 7 shows a system/method for finding assertion violations in a concurrent program.

FIG. 8 shows a system/method for finding atomicity violations in a concurrent program.

FIG. 9 shows a system/method for finding bugs based on a satisfiability approach.

### DETAILED DESCRIPTION OF PREFERRED EMBODIMENTS

The present principles are directed to predictive analysis algorithms with a feasibility guarantee. A given execution trace is regarded as a total order on the events appearing in the trace. Based on happens-before reasoning, one can derive a causal model—a partial order of events—which admits not only the given trace but also many alternative permutations. However, two problems need to be solved in testing for concurrency violations. First, checking all of the feasible interleavings allowed by a causal model for property violations is a bottleneck. Despite the long quest for ever more accurate causal models, little has been done to improve the underlying checking algorithms. Second, these causal models often do not assume that source code is available, and therefore rely on observing only the concrete events during execution. In a concrete event, only the values read from or written to shared memory locations are available, whereas the actual program code that produces the event is not known. Consequently, often unnecessarily strong happens-before causality was imposed to achieve the desired feasibility guarantee.

Similar problems exist in testing for atomicity violations. Atomicity, or serializability, is a semantic correctness condition for concurrent programs. Intuitively, a thread interleaving is serializable if it is equivalent to another thread interleaving which executes the user-intended transactional block without other threads interleaved in between. Much attention has recently been focused on three-access atomicity violations, which involves one shared variable and three consecutive accesses to it. If two accesses in a local thread, which are inside a user-intended transactional block, are interleaved in between by an access in another thread, this interleaving may be unserializable if the remote access has data conflicts with the two local accesses. In practice, unserializable interleavings often indicate the presence of subtle concurrency bugs in the program.

Predictive methods for detecting atomicity violations either suffer from imprecision as a result of conservative modeling (or no modeling at all) of the program data flow (consequently producing many false negatives), or suffer from a very limited coverage of interleavings due to trace-based under-approximations. Because of such approximations, the reported atomicity violations may not exist in the actual program. As with the concurrency violation techniques described above, methods using happens—before causality for atomicity violations often miss many real violations.

The present principles include a symbolic predictive analysis technique to address these problems. It can be assumed that the source code is available for instrumentation to obtain symbolic events at runtime (instrumentation is a process for modifying program source code in order to modify its behavior during execution). Considering these symbolic events allows the present principles to achieve the goal of covering more interleavings. This also facilitates a constraint-based modeling where various concurrency primitives or semantics (locks, semaphores, happens-before, sequential consistency, etc.) are handled easily and uniformly.

A concurrent trace program is introduced below as a predictive model to capture feasible interleavings that can be predicted from a given execution trace. A technique for concurrent static single assignment (CSSA) based representation is introduced for symbolic reasoning with a satisfiability modulo theory (SMT) solver. The symbolic search automatically captures property- or goal-directed pruning through conflict analysis and learning features in modern SMT solvers. A method to symbolically constrain the number of context switches in an interleaving is also disclosed and further improves the scalability of the symbolic algorithm.

Using these principles, techniques are given for improved detection of assertion violations and atomicity violations. The present principles advantageously allow for the detection of many more violations, while still reporting only valid violations. The following description outlines particular examples of the present principles. The description is not intended to be limiting, and alterations made to the following embodiments that fall within the scope and spirit of the claims are also considered.

Concurrent Trace Programs

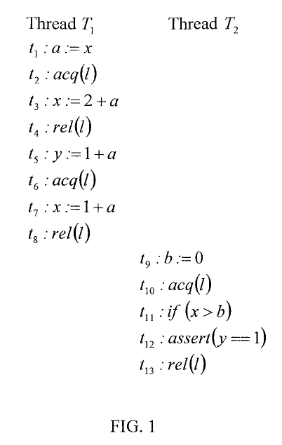

FIG. 1 shows a multithreaded program execution trace. There are two concurrent threads T₁, and T₂, three shared variables x, y and z, two thread-local variables a and b, and a counting semaphore l. The semaphore l can be viewed as an integer variable initialized to 1: acq(l) acquires the semaphore when (l>0) and decreases l by one, while rel(l) releases the semaphore and increases l by one. The initial program state is x=y=0. The sequence ρ=t₁−t₁₁t₁₃ of statements denotes the execution order of the given trace. The correctness property is specified as an assertion in t₁₂. The given trace ρ does not violate this assertion. However, a feasible permutation of this trace, ρ′=(t₁−t₄)t₉t₁₀t₁₁t₁₂t₁₃(t₅−t₈), exposes the error.

None of the sound causal models in the prior art can predict this error. “Sound,” as used herein, means that the predictive technique does not generate false alarms. For example, if happens-before causality is used to define the feasible trace permutations of ρ, the execution order of all read-after-write event pairs in ρ, which are over the same shared variable, is respected. This means that event t₈ must always be executed before t₁₀ and event t₇ must always be executed before t₁₁. These happens—before constraints are sufficient but often not necessary to ensure that the admitted traces are feasible. As a result, many other feasible interleavings are left out.

There have been various causal models proposed that have been aimed at lifting some of the happens-before constraints without jeopardizing the feasibility guarantee. However, when applied to the example in FIG. 1, none of them can predict the erroneous trace ρ′=(t₁−t₄)t₉t₁₀t₁₁t₁₂t₁₃(t₅−t₈). The reason none of the existing models can predict the error in FIG. 1 is that they model events ρ as the concrete values read from or written to shared variables. Such concrete events are tied closely to the given trace. Consider t₁₁: if (x>b), for instance; it is regarded as an event that reads value 1 from variable x. This is a spatial interpretation because other program statements, such as if (b>x), if x>1, and even assignment b:=x, may produce the same event. Consequently, unnecessarily strong happens-before constraints are imposed over event t₁₁ to ensure the feasibility of all admitted traces, regardless of what statement produces the event.

In contrast, the present principles model the execution trace as s sequence of symbolic events by considering the actual program statements that produce ρ and capturing abstract values generated during runtime. In FIG. 1 for example, event t₁₁ is modeled as assume(x>b), where assume(c) means the condition c holds when the event is executed, indicating that t₁₁, is produced by a branching statement and (x>b) is the condition taken. This does not use the happens-before causality to define the set of admitted traces. Instead, one may allow all possible interleavings of these symbolic events as long as the sequential consistency semantics of a concurrent program execution is respected. In the running example, it is possible to move symbolic events t₉-t₁₂ ahead of t₅-t₈ while still maintaining the sequential consistency. As a result, the present principles, while maintaining the feasibility guarantee, are capable of predicting the erroneous behavior in ρ′.

The techniques described below for concurrency and atomicity violations share a common framework. The semantics of an execution trace is defined using a state transition system. Let

$$V = SV ⋃ {⋃}_{i} {LV}_{i} , 1 \leq i \leq k ,$$

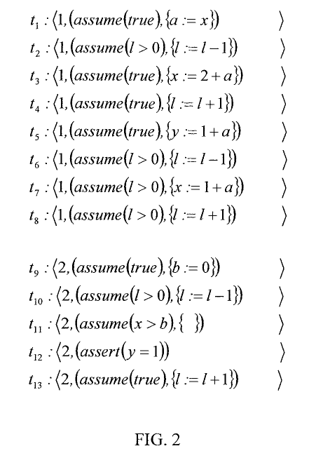

be the set of all program variables and Val be a set of values of variables in V. Referring now to FIG. 2, a symbolic representation of the execution trace of FIG. 1 is shown, having two threads and the starting state of x=y=0. A state is a map s:V→Val assigning a value to each variable. One may use s[v] and s[exp] to denote the values of vεV and expression exp in state s. A state transition exists,

$$s {\to }^{t} {s}^{′}$$

where s, s′ are states and t is an event in thread Tᵢ, 1≦i≦k, if and only if the following conditions hold:

t= [symbol] i,(assume(c),asgn) [symbol] , s[c] is true, and for each assignment lval:=exp in asgn, s′[lval]=s[exp] holds; states s and s′ agree on all other variables; and

t= [symbol] i, assert(c) [symbol] and s[c] is true. When s[c] is false, an attempt to execute event t raises an error.

Let ρ=t₁ . . . tₙ be an execution trace of program P. If is a feasible execution if there exists a state sequence s₀, . . . , sₙ such that, s₀ is the initial state of program P and for all i=1, . . . , n, there exists a transition

$${s}_{i - 1} {\to }^{{t}_{i}} {s}_{i} .$$

An execution trace ρ is a total order on the symbolic events. From ρ one may derive a partial order called the concurrent trace program (CTP). The concurrent trace program of ρ is a partially ordered set CTP_{ρ}=(T,⊂) such that,

T={t|tερ} is the set of events, and

⊂ is a partial order such that, for any tᵢ, tⱼ,εT, tᵢ⊂tⱼ if and only if tid(tᵢ)=tid(tⱼ) and i<j (in ρ, event tᵢ appears before tⱼ).

Intuitively, CTP_{ρ} orders events from the same thread by their execution order in ρ; events from different threads are not explicitly ordered with each other. Keeping events symbolic and allowing events from different threads remain unordered with each other is a significant advantage of the present principles over prior art techniques.

The feasibility of admitted traces is guaranteed through the notion of feasible linearizations of CTP_{ρ}. A linearization of this partial order is an alternative interleaving of events in ρ; due to the sequential consistency execution semantics of concurrent programs, some linearizations may not appear in the actual program execution. (Recall that synchronization primitives are modeled using auxiliary shared variables in atomic guarded assignment events.) Let ρ′=t′₁ . . . t′ₙ be a linearization of CTP_{ρ}. ρ′ is a feasible linearization if and only if there exist states s₀, . . . , sₙ such that, s₀ is the initial state of the program and for all i=1, . . . , n, transitions

$${s}_{i - 1} {\to }^{{t}_{i}^{′}} {s}_{i}$$

exists.

Given the execution trace ρ, one may derive the model CTP_{ρ} and symbolically check all its feasible linearizations for property violations. For this, one may create a formula Φ_{CTP}_{_{ρ}}, such that Φ_{CTP}_{_{ρ}} is satisfiable if and only if there exists a feasible linearization that violates the property. Specifically, an encoding is used that creates the formula in a quantifier-free, first-order logic.

This encoding is based on transforming the trace program into a concurrent static single assignment (CSSA) form. The CSSA form has the property that each variable is defined exactly once. Here a definition of variable vεV is an event that modifies v, and a use of v is an event where it appears in an expression. In this case, an event defines v if and only if v appears in the left-hand-side of an assignment; an event uses v if and only if v appears in a condition (an assume or the assert) or the right-hand-size of an assignment.

Unlike in classic sequential SSA form, one need not add φ-functions to model the confluence of multiple if-else branches, because in a concurrent trace program each thread has a single control path. The branching decisions have already been made during the program execution.

One may differentiate shared variables in SV from thread-local variables in LVᵢ where 1≦i≦k. Each use of variables v εLVᵢ corresponds to a unique definition, a preceding event in the same thread Tᵢ that defines v. For shared variables, however, each use of variable vεSV may map to multiple definitions due to thread interleaving. A π-function is added to model the confluence of these possible definitions. A π-function, introduced for a shared variable v immediately before its use, has the form π(v₁, . . . , vₖ), where each vᵢ, 1≦i≦k, is either the most recent definition of v in another concurrent thread. These π-functions represent memory consistency constraints.

Therefore, the construction of CSSA includes the following steps: 1. Create unique names for local/shared variables in their definitions; 2. For each use of a local variable vεLVᵢ, 1≦i≦k, replace v with the most recent (unique) definition v′; 3. For each use of a shared variable vεSV, create a unique name v′ and add the definition v′←π(v₁, . . . , vₖ). Then replace v with the new definition v′. Let v′←π(v₁, . . . , vₖ) be defined in event t and each parameter vᵢ, 1≦i≦k be defined in event tᵢ. The π-function may return any of the k parameters as the result depending on the write-read consistency in a particular interleaving. Intuitively, (v′=vᵢ) in an interleaving if and only if vᵢ is the most recent definition before event t. More formally, (v′=vᵢ), where 1≦i≦k, holds if and only if the following condition holds,

event tᵢ, which defines vᵢ, is executed before event t; and

any event tⱼ that defines vⱼ, 1≦i≦k and j≠i, is executed either before the definition in tᵢ or after the use in t.

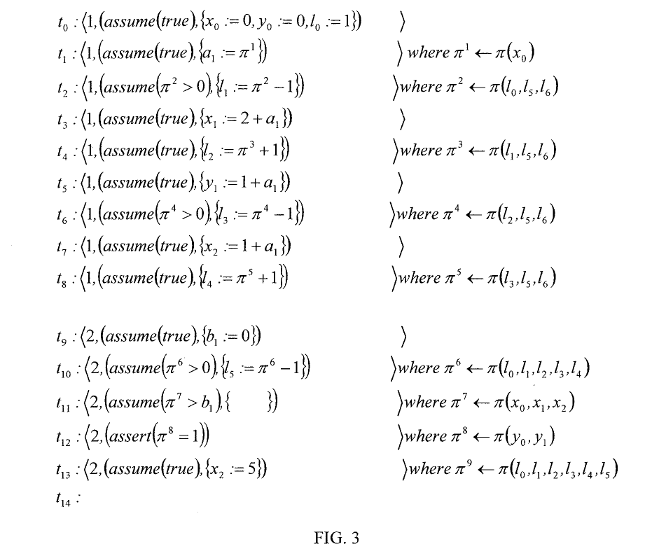

As an example, FIG. 3 shows the CSSA form of the CTP in FIG. 2. Names π¹-π⁹ and π-functions are added for the shared variable uses. The condition (x>b) in t₁₁ becomes (π⁷>b₁) where π⁷←π(x₀, x₁, x₂) and b₁ denotes the value of b defined in t₉. The names x₀, x₁, x₂ denote the values of x defined in t₀, t₃ and t₇, respectively.

CSSA-Based Satisfiability (SAT) Formula

A quantifier-free first-order logic formula Φ_{CTP} is generated based on the notion of feasible linearizations of CTP and the π-function semantics. The construction is straight forward and follows their definitions. The entire formula Φ_{CTP} consists of the following four subformulas:

Φ_{CTP}:=Φ_{PO} [symbol] Φ_{VD} [symbol] Φ_{PI} [symbol] [symbol] PRP,

where Φ_{PO} encodes the program order, Φ_{VD} encodes the variable definitions, and Φ_{PI}, encodes the π-functions, and Φ_{PRP} encodes the property. Formula Φ_{CTP} is satisfiable if and only if there exists a feasible linearization of the CTP that violates the given property.

The following notations are helpful to present the encoding algorithm:

First Event t_{first}: add a dummy event t_{first}, to be the first event executed in the CTP. That is, ∀tεCTP and t≠t_{first} event t must be executed after t_{first};

Last event tₗₐₛₜ: add a dummy event tₗₐₛₜ, to be the last executed event in the CTP. That is, ∀tεCTP and t≠tₗₐₛₜ, event t must be executed after tₗₐₛₜ;

First Event t_{first}ⁱ of Thread Tᵢ: for each iεTid, this is the first event of the thread;

Last event tₗₐₛₜⁱ of Thread Tᵢ: for each iεTid, this is the last event of the thread;

Thread-local preceding event: for each event t, define its thread-local preceding event t′ as follows; tid(t′)=tid(t) and t″εCTP such that t″≠t′, t″=t, and tid(t″)=tid(t), either t″⊂t′ or t⊂t″.

HB-constraint: one may use HB(t,t′), to denote that event t is executed before t′. The actual constraint comprising HB(t,t′) is given in below.

For each event tεCTP_{ρ}, the path condition g(t) is defined such that t is executed if and only if g(t) is true. The path conditions are computed as follows:

1. If t=t_{first}, or t=t_{first}ⁱ where iεTid, let g(t):=true.

2. Otherwise, t has a thread-local preceding event t′.
if t has action (assume(c), a sgn), let g(t):=c [symbol] g(t′);
if t has action assert(c), let g(t)=g(t′).

Intuitively, Φ_{PO} captures the event order within each thread. It does impose any inter-thread constraint. Let Φ_{PO}:=true initially. For each event tεCTP_{ρ},

1. if t=t_{first}, do nothing;

2. if t=_{first}ⁱ where iεTid, let Φ_{PO}:=Φ_{PO} [symbol] HB(t_{first},t_{first}ⁱ);

3. if t=tₗₐₛₜⁱ, let Φ_{PO}:=Φ_{PO} [symbol] Λ_{∀iεTid}HB(tₗₐₛₜⁱ,tₗₐₛₜ);

4. Otherwise, t has a thread-local preceding event t′; let Φ_{PO}:=Φ_{PO} [symbol] HB(t′,t).

Formula Φ_{VD} is the conjunction of all variable definitions. Let Φ_{VD}:=true initially. For each event tεCTP_{ρ},
1. if t has action (assume(c),asgn), for each assignment lval:=exp in asgn, let Φ_{VD}:=Φ_{VD} [symbol] (lval=exp);
2. Otherwise, do nothing.

Each π-function defines a new variable v′, and Φ_{PI} is a conjunction of all these variable definitions. Let Φ_{PI}:=true initially. For each v′←π(v₁, . . . vₖ) defined in event t, where v′ is used also assume that each vᵢ, where 1≦i≦k is defined in event tᵢ. Let

$${Φ}_{PI} := {Φ}_{PI} ⋀ {}_{i = 1}^{k} ( {v}^{′} = {v}_{i} ) ⋀ g ( {t}_{i} ) ⋀ HB ( {t}_{i} , t ) ⋀ {Λ}_{j = 1 , j \neq i}^{k} ( HB ( {t}_{j} , {t}_{i} ) ⋁ HB ( t , {t}_{j} ) ) .$$

Intuitively, the π-function evaluates to vᵢ if and only if it chooses the i-th definition in the π-set such that other definitions vⱼ, j≠i, are either before tᵢ or after this use of vᵢ in t.

Let tεCTP be the event with action assert(c), which specifies the correctness property. The property Φ_{PRP} is defined as:

Φ_{PRP}:=(g(t)→c)

Intuitively, the assertion condition c must hold if t is executed. Recall that Φ_{PRP} is negated in Φ_{CTP}_{_{ρ}} to search for property violations.

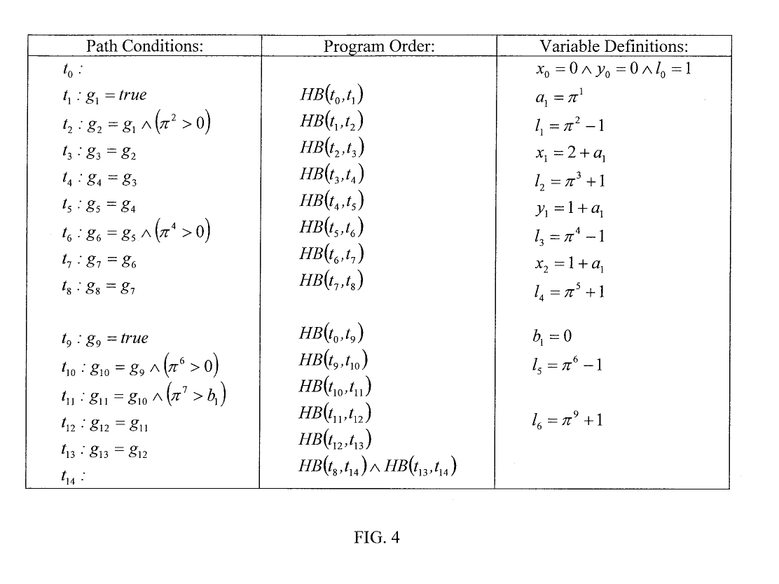

Referring now to FIG. 4, an example of a CSSA-based encoding with relation to the CTP of FIG. 3 is shown. The subformulas which make up Φ_{PO} and Φ_{VD} are listed in FIG. 3. Φ_{PRP} (at t₁₂) is defined as [symbol] g₁₂ [symbol] (π⁸=1). In the figure, t₀, t₁₄ are the dummy entry and exit events. The subformula in Φ_{PI} for the π-function t₁₁ is defined as follows:

| | |
|---|---|
| t₁₁:(π⁷ = x₀ [symbol] (true) | [symbol] HB(t₁₁,t₃) [symbol] HB(t₁₁,t₇) |

[symbol]

π⁷ = x₁ [symbol] (g₃ [symbol] HB(t₃,t₁₁)) [symbol] true [symbol] HB(t₁₁,t₇) [symbol]
π⁷ = x₂ [symbol] (g₇ [symbol] HB(t₇,t₁₁)) [symbol] true [symbol] true
)

Note that some of the HB-constraints evaluate to true statically—such simplification is frequent and is performed in our implementation to reduce the size of the final formula.

Symbolic Context Bounding

Traditionally, a context switch is defined as the computing process of storing and restoring the CPU state (context) when executing a concurrent program, such that multiple processes or threads can share a single CPU resource. Concurrency bugs in practice can often be exposed in interleavings with a surprisingly small number of context switches (say 3 or 4).

Referring again to the example of FIG. 1, if the number of context switches of an interleaving are restricted to one, there are only two possibilities:

ρ′=(t₁t₂ . . . t₈)(t₉t₁₀ . . . t₁₃)

ρ″=(t₉t₁₀ . . . t₁₃)(t₁t₂ . . . t₈).

In both cases, the context switch happens when one thread completes its execution. However, none of the two traces is erroneous and ρ″ is not even a feasible permutation. When the context bound is increased to 2, the number of admitted interleavings remains small but now the following trace is admitted:

ρ′″=(t₁t₂t₃)(t₉t₁₀t₁₁t₁₂)(t₄ . . . t₈).

The trace has two context switches and exposes the error in t₁₂ (where y=0).

HB(t,t′) is defined above as O(t)<O(t′). However, such a strictly-less-than constraint is sufficient, but not necessary, to ensure the correctness of the encoding. To facilitate the implementation of context hounding, the definition of the HB(t,t′) constraint is modified as follows:

1. HB(t,t′):=O(t)≦O(t′) if one of the following condition holds:
tid(t)=tid(t′), or
t′=tₗₐₛₜ.

2. HB(t,t′):=O(t)≦O(t′) otherwise.

Note that first, if two events t and t′ are from the same thread, the execution time O(t) need not be strictly less than O(t′) to enforce HB(t,t′). This is because the CSSA form, through the renaming of definitions and uses of thread-local variables, already guarantees the flow-sensitivity within each thread. That is, implicitly, a definition always happens before the subsequent uses. Therefore, when tid(t)=tid(t′), one may relax the definition of HB(t,t′) by using less than or equal to.

Second, if events t and t′ are from two different threads (and t≠t_{first} and t≠tₗₐₛₜ) according to the above encoding rules, the constraint HB(t,t′) must be introduced by the subformula Φ_{PI} encoding π-functions. In such a case, HB(t,t′) means that there is at least one context switch between the execution of t and t′. Therefore, when tid(t)≠tid(t′), the present principles force event t to happen strictly before event t′ in time.

Let k be the maximal number of context switches allowed in an interleaving. In practice, k is empirically set to a small integer. Given the formula Φ_{CTP}_{_{ρ}} as defined above, one may construct the context-bounded formula Φ_{CTP}_{_{ρ}}(k) as follows:

Φ_{CTP}_{_{ρ}}(k)=Φ_{CTP}_{_{ρ}} [symbol] (O(tₗₐₛₜ)−O(t_{first})≦k)

The additional constraint states that tₗₐₛₜ the unique exit event, may be executed no more than k steps later than t_{first} the unique entry event.

The execution times of the events in a feasible trace always form a non-decreasing sequence. Furthermore, the execution time is forced to increase whenever a context switch happens, i.e., as a result of HB(t,t′) when tid(t)≠tid(t′). In the above context-bound constraint, such increases of execution time are limited to less than or equal to k times.

It can be shown that, if CB(ρ′)≦k and ρ′ violates a correctness property, then Φ_{CTP}_{_{ρ}}(k) is satisfiable, where ρ′ is a feasible linearization of CTP_{ρ} and CB(ρ′) is the number of context switches in ρ′. By the same reasoning, if CB(ρ′)>k, trace ρ′ is excluded by formula Φ_{CTP}_{_{ρ}}(k).

In the context bounded analysis, one can empirically choose a bound CB and check the satisfiability of formula Φ_{CTP}_{_{ρ}}(CB). Alternatively, one can iteratively set k=1, 2, . . . , CB and, for each k, check the satisfiability of the formula

Φ_{CTP}_{_{ρ}} [symbol] (O(tₗₐₛₜ)−O(t_{first})=k).

In both cases, if the formula is satisfiable, an error has been found. Otherwise, the SMT solver used to decide the formula will return a subset of the given formula as a proof of unsatisfiability. More formally, the proof of unsatisfiability of a formula f, which is unsatisfiable, is a subformula fᵤₙₛₐₜ of f such that fᵤₙₛₐₜ itself is also unsatisfiable. The addition of context-bounding renders the present techniques efficient enough to be used for on-line bug detection. The above formulation of context bounding relates specifically to the framework of symbolic predictive analysis, and is not represented in the prior art.

Atomicity Violations

The above techniques may also be applied to finding atomicity violations in concurrent programs. The resulting technique is more accurate than prior-art methods, while not producing false positives. Given an execution trace on which transactional blocks are explicitly marked, one can check all alternative interleavings of the symbolic events of that trace for three-access atomicity violations. The symbolic events are constructed from both the concrete trace and the program source code. The present principles may be applied as follows:

1. Run a test of the concurrent program to obtain an execution trace.

2. Run a sound but over-approximate algorithm to detect all potential atomicity violations. If no violation is found, return.

3. Build the precise predictive model, and for each potential violation, check whether it is feasible.

Step 3 above may be formulated as a satisfiability problem by constructing a formula which is satisfiable if and only if there exists a feasible and yet unserializable interleaving of events of the given trace. The formula is in a quantifier-free, first-order logic and is decided by a Satisfiability Modulo Theory (SMT) solver. The symbolic, predictive model and the subsequent analysis using an SMT solver differ substantially from techniques described in the prior art. The model tracks the actual data flow and models all synchronization primitives precisely. The greater capability of covering interleavings is due to the use of concrete trace as well as the program source code. Furthermore, using symbolic techniques rather than explicit enumeration makes the analysis less sensitive to the large number of interleavings.

An execution trace ρ is serializable if and only if it is equivalent to a feasible linearization ρ′ of CTP_{ρ} which executes the intended transaction without other threads interleaved in between. Two traces are equivalent if and only if one can transform one into another by repeatedly swapping adjacent independent events. Here two events are independent if and only if swapping their execution order always leads to the same program state.

Three-access atomicity violation is a special case of serializability violations, involving an event sequence t_{c} . . . tᵣ . . . t_{c′}, such that:

1. t_{c} and t_{c′}, are in a transactional block of one thread, and tᵣ is in another thread;

2. t_{c} and tᵣ have data conflict; and tᵣ and t_{c′} have data conflict.

In practice these atomicity violations account for a large number of concurrency errors. Depending on whether each event is a read or write, there are eight combinations of the triplet t_{c}, tᵣ, t_{c′}. While R-R-R, R-R-W, and W-R-R are serializable, the remaining five indicate atomicity violations.

Given the CTP_{ρ} and a transactional block trans=tᵢ . . . tⱼ, where tᵢ . . . tⱼ are events from the same thread in ρ, one can use the set PAV to denote all these potential atomicity violations. Conceptually, the set PAV can be computed by scanning the trace ρ once, and for each remote event tᵣεCTP_{ρ} finding the two local events t_{c}, t_{c′}εtrans such that [symbol] t_{c},tᵣ,t_{c′} [symbol] forms a non-serializable pattern.

Deciding whether an event sequence t_{c} . . . tᵣ . . . t_{c′} exists in the actual program execution is difficult. However, over-approximate algorithms can be used to prune away event triplets in PAV that are definitely infeasible. One method reduces the problem of checking (the existence of) t_{c} . . . tᵣ . . . t_{c′} to simultaneous reachability under nested locking. That is, does there exist an event t_{c″} such that (1) t_{c″} is within the same thread and is located between t_{c} and t_{c′}, and (2) t_{c″}, tᵣ are simultaneously reachable. Simultaneous reachability under nested locking can be checked by a compositional analysis based on locksets and acquisition histories. However, this analysis is over-approximate in that it ignores the data flow and synchronization primitives other than nested locks.

Sometimes, two events with data conflict may still be independent to each other, although they are conflict-dependent. A data conflict occurs when two events access the same variable and at least one of them is a write. The conflict-independence between two events is defined as: (1) executing one does not enable/disable another; and (2) they do not have data conflict. These conditions are necessary but insufficient for two events to be truly independent. Consider event t₁: x=5 and event t₂: x=5, for example. They have a data conflict but arc semantically independent. An independence relation may be more precisely defined, wherein two events t₁,t₂ are guarded independent with respect to a condition c_{G} I and only if c_{G} implies that the following properties:
1. if t₁ is enabled in s and

$$s {\to }^{{t}_{1}} {s}^{′}$$

then t₂ is enabled in s if and only if t₂ is enabled in s′: and
2. if t₁, t₂ are enabled in s, there is a unique state s′ such that

$$s {⇒}^{{t}_{1} {t}_{2}} {s}^{′} and s {⇒}^{{t}_{2} {t}_{1}} {s}^{′} .$$

The guard c_{G} is computed by statically traversing the CTP or program structure. For each event tεCTP_{ρ} let V_{RD}(t) be the set of variables read by t, and V_{WR}(t) be the set of variables, written by t. The potential conflict set between events t₁ and t₂ is defined as:

Cₜ _{₁},tₜ _{₂}=V_{RD}(t₁)∩V_{WR}(t₂)∪V_{RD}(t₂)∩V_{WR}(t₁)∪V_{WR}(t₁)∩V_{WR}(t₂).

For programs with pointers (* p) and arrays (a[i]), the guarded independence relation R_{G} is computed as follows:

1. when Cₜ _{₁}_{,t} _{₂}=0, add [symbol] t₁, t₂,true [symbol] to R_{G};

2. when Cₜ _{₁}_{,t} _{₂}={a[i],a[j]}, add [symbol] t₁,t₂,i≠j [symbol] to R_{G};

3. when Cₜ _{₁}_{,t} _{₂}={*pᵢ,*pᵢ}, add [symbol] t₁,t₂,pᵢ≠pⱼ [symbol] to R_{G};

4. when Cₜ _{₁}_{,t} _{₂}={x}, consider the following cases:
a. RD-WR: if xεV_{RD}(t₁) and x:=e is in t₂, add [symbol] t₁, t₂,x=e [symbol] to R_{G};
b. WR-WR: if x:=e₁ is in t₁ and x:=e₂ is in t₂, add [symbol] t₁,t₂,x=e₁=e₂ [symbol] to R_{G};
c. WR-C: if x is in assume condition cond of t₁, and x:=e is in t₂, add [symbol] t₁,t₂,cond=cond [x→e] [symbol] to R_{G} in which cond [x→e] denotes the replacement of x with e.

This set of rules can be readily extended to handle a richer set of language constructs. Note that among these patterns, the syntactic conditions based on data conflict is able to catch the first pattern only. In symbolic search based on SMT/SAT solvers, the guarded independence relation is compactly encoded as constraints in the problem formulation, as described below.

Given the CTP_{ρ} and a set PAV of event triplets as potential atomicity violations, one can precisely check whether a potential violation exists in any feasible linearization of CTP_{ρ}. For this, a formula Φ is generated which is satisfiable if and only if there exists a feasible linearization of CTP_{ρ} that exposes the violation. Let Φ=Φ_{CTP}_{_{ρ}} [symbol] Φ_{AV}, where Φ_{CTP}_{_{ρ}} captures all the feasible linearizations of CTP_{ρ} as described above and Φ_{AV}, encodes the condition that at least one event triplet exists. Note that this formulation does not involve the assertion property Φ_{PRP} described above. As a result, the function Φ=Φ_{PO} [symbol] Φ_{VD} [symbol] Φ_{PI} [symbol] Φ_{AV}.

Given a set PAV of potential violations, one may build formula Φ_{AV} as follows;

1. Initialize Φ_{AV}:=false;

2. For each event triplet [symbol] t_{c},tᵣ,t_{c′} [symbol] εPAV, let

Φ_{AV}:=Φ_{AV} [symbol] (HB(t_{c},tᵣ) [symbol] HB(tᵣ,t_{c′}))

Recall that for two events t and t′, the constraint HB(t, t′) denotes that t must be executed before t′. Consider a model introducing for each event tεCTP a fresh integer variable O(t) that denotes its position in the linearization (execution time). A satisfiable assignment to Φ_{CTP}_{_{ρ}} therefore induces values of O(t) (e.g. positions of all events in the linearization).

Recall that HB(t, t′) is defined as follows:

HB(t,t′):=O(t)<O(t′).

In SMT, HB(t, t′) corresponds to a constraint in special type of Integer Difference Logic (IDL), i.e. O(t)<O(t′) or simply O(t)−O(t′)≦−1. It is special in that the integer constant c in (x−y≦c), where x and y are integer variables, is always −1. Deciding this fragment of IDL is easier because consistency can be checked by a cycle detection algorithm in the constraint graph, which is O(|V|+|E|) where |V| and |E| are the number of nodes and edges, respectively, rather than by a negative-cycle detection algorithm, which has the best-known complexity of O(|V|×|E|).

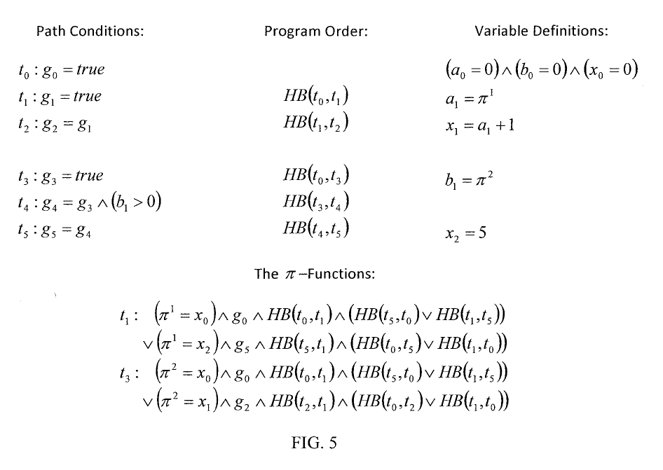

Referring now to FIG. 5, a CSSA-based encoding of a CTP is shown. Note that it is common for many path conditions, variable definitions, and HB-constraints to be constants. For example, HB(t₀,t₁) and HB(t₀,t₅) in FIG. 5 are always true, while HB(t₅,t₀) and HB(t₁,t₀) are always false. Such simplifications are frequent and will lead to significant reduction in formula size.

For synchronization primitives such as locks, there are even more opportunities to further simplify the SAT formula. For example, if π¹←π(l₁, . . . , lₙ) denotes the value read from a lock variable l during lock acquire, then it is evident that that π¹=0 must hold, since the lock need to be available for it to be acquired. This means that for parameters that are not 0, the constraint π¹=lᵢ, where 1≦i≦n, evaluates to false. Due to the mutex lock semantics, for all 1≦i≦n, lᵢ=0 if and only if lᵢ is defined by a lock release.

The encoding of Φ=Φ_{CTP}_{_{ρ}} [symbol] Φ_{AV} closely follows the definitions of CTP, feasible linearizations, and the semantics of it π-functions. The formula Φ is satisfiable if and only if there exists a feasible linearization of the CTP that violates the given atomicity property.

Let n be the number of events in CTP_{ρ}, let n_{π} be the number of shared variable uses, let l_{π} be the maximal number of parameters in any π-function, and let lₜᵣₐₙₛ be the number of shared variable accesses in trans. One may also assume that each event in ρ accesses at most one shared variable. The size of (Φ_{PO} [symbol] Φ_{VD} [symbol] Φ_{PI} [symbol] Φ_{AV}) is O(n+n+n_{π}×l_{π}²+n_{π}×lₜᵣₐₙₛ). Note that shared variable accesses in a concurrent program are often kept few and far in between, especially when compared to computations within threads, to minimize the synchronization overhead. This means that l_{π}, n_{π}, and lₜᵣₐₙₛ are typically much smaller than n, which significantly reduces the formula size. In contrast, conventional bounded model checking (BMC) algorithms, if they were to be applied to a CTP, would need to unroll the transition relation of the CTP up to n times in order to cover all linearizations; at each step, the transition relation needed to encode all events of the CTP needs to be duplicated, leading to the formula size 0(n²). The BMC formula size cannot be easily reduced even if l_{π}, n_{π}, and lₜᵣₐₙₛ are significantly smaller than n.

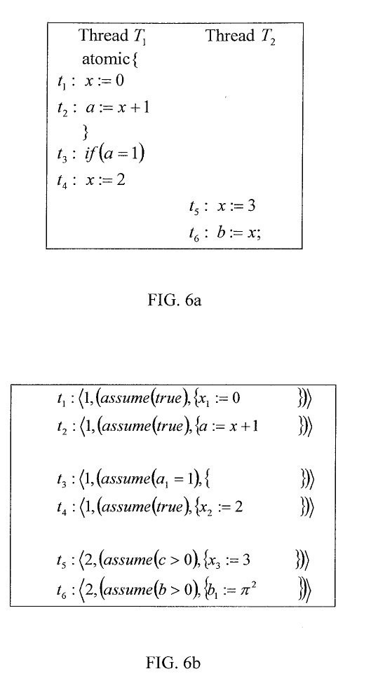

Sometimes, the existence of an atomicity violation leads the execution to take a branch that is not in the CTP_{ρ}. Consider the example in FIGS. 6a and b, wherein FIG. 6a shows a particular execution trace, and FIG. 6b shows an erroneous prefix. In this trace, event t₄ is guarded by condition (a=1). There is a real atomicity violation under thread schedule t₁t₅t₂ . . . . However, this trace prefix leads to the condition (a=1) in event t₃ being evaluated to false. Event t₄ will be skipped as a result. In this sense, the trace t₁t₅t₂ . . . does not qualify as a linearization of CTP_{ρ}. In the aforementioned symbolic encoding, the π-constraint in t₆ will become invalid, and therefore rule out the trace t₁t₅t₂ . . . . The π-function constraints are:

t₂: (π¹=x₁) [symbol] g₁ [symbol] HB(t₁,t₂) [symbol] (HB(t₅,t₁) [symbol] HB(t₂,t₅))

[symbol] (π¹=x₃) [symbol] g₅ [symbol] HB(t₅,t₂) [symbol] (HB(t₁,t₅) [symbol] HB(t₂,t₁))

t₆: (π²=x₁) [symbol] g₁ [symbol] HB(t₁,t₆) [symbol] HB(t₄,t₁) [symbol] HB(t₆,t₄)) [symbol] HB(t₅, t₁) [symbol] HB(t₆, t₅))

[symbol] (π¹=x₂) [symbol] g₄ [symbol] HB(t₄,t₆) [symbol] HB(t₁,t₄) [symbol] HB(t₆,t₁)) [symbol] HB(t₅,t₄) [symbol] HB(t₆,t₅))

[symbol] (π²=x₃) [symbol] g₅ [symbol] HB(t₅,t₆) [symbol] (HB(t₁,t₅) [symbol] HB(t₆,t₁)) [symbol] (HB(t₄,t₅) [symbol] HB(t₆,t₄))

In trace t₁t₅t₂ . . . , g₄=false, HB(t₄,t₁)=HB(t₆,t₄)=false, and
HB(t₄,t₅)=HB(t₆,t₄)=false.

Such an execution trace ρ′ is not a feasible linearization of CTP_{ρ}, although it has exposed a real atomicity violation. The symbolic encoding of formula Φ is now extended to capture this type of erroneous trace prefix (as opposed to the entire erroneous trace). The symbolic encoding is extended as follows. Let event triplet {t_{c},tᵣ,t_{c′}} be the potential violation. Modify the construction of Φ_{PI} (for the π-function in event t) as follows:

$${Φ}_{PI} := {Φ}_{PI} ⋀ ( HB ( {t}_{{r}^{′}} , t ) ⋁ {⋁}_{i = 1}^{l} ( {v}^{′} = {v}_{i} ) ⋀ g ( {t}_{i} ) ⋀ HB ( {t}_{i} , t ) ⋀ {Λ}_{j = 1 , j \neq i}^{l} ( HB ( {t}_{j} , {t}_{i} ) ⋁ HB ( t , {t}_{j} ) ) ) .$$

That is, if the atomicity violation bas already happened, as indicated by the current event, t (which uses this π-function) happens after t_{c′}, then do not enforce any read-after-write consistency. The rest of the encoding algorithm remains the same.

The above technique generates an SMT formula such that the violation of an atomicity property exists if and only if the SMT formula is satisfiable. The algorithm does not report bogus errors (i.e., false positives) and, at the same time, achieves a better interleaving coverage than the previously existing explicit-state methods for predictive analysis.

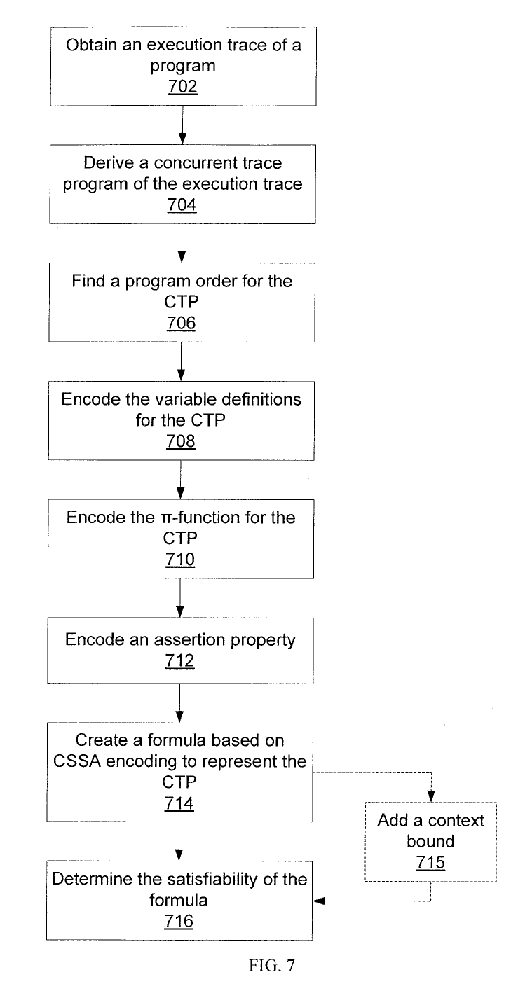

Referring now in detail to the figures in which like numerals represent the same or similar elements and initially to FIG. 7, a system/method is shown for symbolic predictive error analysis for concurrent programs, allowing users to quickly find assertion violations. Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

Referring again to FIG. 7, the present principles begin by obtaining an execution trace of a program at block 702. This execution trace may be based on a concrete trace (in other words, upon a trace generated by actually running the program) as well as the source code for the program itself A CTP is then derived based on the execution trace at block 704. In a preferred embodiment, the CTP will include all of the alternative traces, representing alternative orders of execution.

In order to build a CSSA encoding for the CTP, first the program order Φ_{PO} is encoded at block 706. Second, the variable definitions are encoded as Φ_{VD} at block 708. Next the π-function is encoded as Φ_{PI} at block 710. Finally the assertion property Φ_{PRP} is encoded at block 712. These formulas are incorporated into a formula for the CTP Φ_{CTP} at block 714. Determining whether there exists a feasible linearization that violates the assertion property is then a simple matter of determining the satisfiability of Φ_{CTP} at block 716.

As an optional step, a context bound may be introduced at block 715, before determining the satisfiability of the formula. This context bound limits the number of context switches allowed in an interleaving. Given that many concurrency bugs may be exposed in interleavings with only a small number of context switches, the introduction of a context bound may lead to a significant increase in efficiency with only a modest decrease in accuracy.

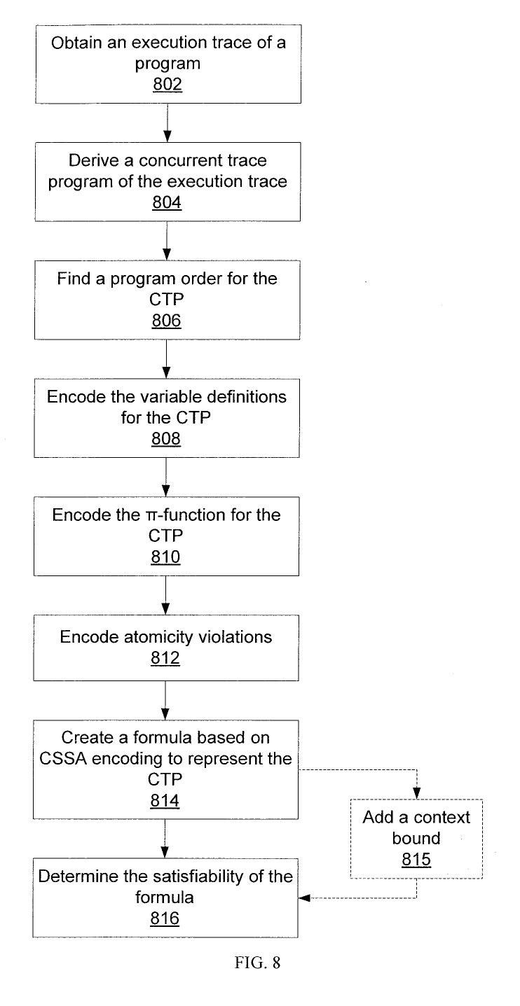

Referring now to FIG. 8, the present principles are applied to finding atomicity violations in feasible linearizations. The technique mirrors that described above with respect to FIG. 7. First, an execution trace of the program is obtained at block 802, wherein such trace may be based on concrete execution events as well as the source code for the program. Next, a concurrent trace program is found for the execution trace at block 804. Next, a program order for the CTP is encoded at block 806, variable definitions are encoded at block 808, and the π-functions are encoded at block 810. Optionally, the π-functions at block 810 may be modified to capture erroneous trace prefixes.

Block 812 encodes the atomicity violations, as described above. By joining the formula for atomicity violations with the above encodings, a formula based on CSSA encoding that represents atomicity violations in the program is constructed at block 814. Finally, by determining the satisfiability of the formula at block 816, one may determine whether the program includes feasible linearizations that violate the atomicity property.

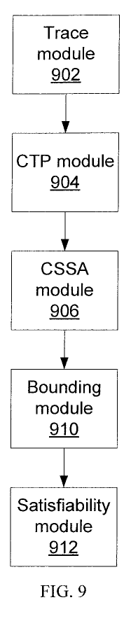

Referring now to FIG. 9, a system for symbolic predictive analysis is shown to find bugs in programs. A trace module 902 runs a program under test at least once and creates a concrete execution trace. The trace module 902 may also have access to the program's source code, allowing for alternative traces to be tested. A CTP module 904 then uses the output of the trace module 902 to create a CTP for the program under test. A CSSA module 906 uses the CTP generated by CTP module 904 to create a formula based on a CSSA encoding of the CTP. The CSSA module 906 may include in the formula an assertion property, an atomicity violation, or other concurrency tests. Optionally, a bounding module 910 imposes a limitation on the number of context switches permitted in the formula. Finally, a satisfiability module 912 determines the satisfiability of the formula, thereby determining whether a violation exists in the program.

Embodiments according to the present principles are able to find bugs in a program under test more efficiently and more accurately than prior art systems, while still not over-predicting such violations. The present principles thereby allow for on-line violation detection and represent a significant advance over the prior art.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A symbolic predictive analysis method for finding assertion violations in concurrent programs, comprising:
deriving a concurrent trace program (CTP) for a program under a given test;
generating a logic formula based on a concurrent static single assignment (CSSA) representation of the CTP, wherein the formula includes all feasible executions of the CTP and at least one assertion property;
determining the satisfiability of the formula using a processor, wherein a determination of formula satisfiability indicates an assertion violation.

2. The method of claim 1, further comprising the step of generating a symbolic execution trace representation for a program under test, wherein the CTP is derived from said symbolic execution trace.

3. The method of claim 2, wherein the symbolic execution trace representation is based on a concrete execution trace and the source code of the program under test.

4. The method of claim 1, wherein the logic formula is a satisfiability modulo theory formula.

5. The method of claim 1, wherein the logic formula further includes constraints due to a program order of the CTP.

6. The method of claim 5, wherein the logic formula further includes constraints due to variable definitions in the CSSA representation of the CTP.

7. The method of claim 6, wherein the formula further includes memory consistency constraints in the CSSA representation of the CTP.

8. The method of claim 1, further comprising the step of adding a context bound in the logic formula to limit the number of context switches.

9. A computer readable medium that stores a computer readable program, wherein the computer readable program when executed on a computer causes the computer to perform the steps of claim 1.

10. A symbolic predictive analysis method for finding atomicity violations in concurrent programs, comprising:
deriving a concurrent trace program (CTP) for a program under a given test;
generating a logic formula based on a concurrent static single assignment (CSSA) representation of the CTP, wherein the formula includes all feasible executions of the CTP and at least one atomicity violation;
determining the satisfiability of the formula using a processor, wherein a determination of formula satisfiability indicates an atomicity violation.

11. The method of claim 10, further comprising the step of generating a symbolic execution trace representation for a program under test, wherein the CTP is derived from said symbolic execution trace.

12. The method of claim 11, wherein the symbolic execution trace representation is based on a concrete execution trace and the source code of the program under test.

13. The method of claim 10, wherein the logic formula is a satisfiability modulo theory formula.

14. The method of claim 10, wherein the logic formula further includes constraints due to a program order of the CTP.

15. The method of claim 14, wherein the logic formula further includes constraints due to variable definitions in the CS SA representation of the CTP.

16. The method of claim 15, wherein the formula further includes memory consistency constraints in the CSSA representation of the CTP.

17. The method of claim 16, wherein the memory consistency constraints capture erroneous trace prefixes.

18. The method of claim 10, further comprising the step of adding a context bound in the logic formula to limit the number of context switches.

19. A computer readable medium that stores a computer readable program, wherein the computer readable program when executed on a computer causes the computer to perform the steps of claim 10.

20. A symbolic predictive analysis system for finding concurrency violations in concurrent programs, comprising:
a concurrent trace program (CTP) module that derives a CTP for a program under a given test;
a concurrent static single assignment (CSSA) module that generates a logic formula based on a CSSA representation of the CTP, wherein the formula includes all feasible executions of the CTP and a condition for a concurrency violation;
a satisfiability module that determines the satisfiability of the formula using a processor, wherein a determination of formula satisfiability indicates a concurrency violation.

21. The method of claim 20, further comprising a trace module that creates an execution trace representation for a program under test, wherein the CTP module uses said symbolic execution trace to derive the CTP.

22. The method of claim 20, further comprising a bounding module that imposes a context bound on the logic formula.
